(19) United States
(12) Patent Application Publication
(10) Pub. No.: US 2025/0234410 A1
(43) Pub. Date: Jul. 17, 2025

(54) METHOD AND APPARATUS FOR CONFIGURING IP ADDRESS TO INTEGRATED ACCESS AND BACKHAUL NODE IN WIRELESS COMMUNICATION SYSTEM

(71) Applicant: Samsung Electronics Co., Ltd., Gyeonggi-do (KR)

(72) Inventor: June HWANG, Gyeonggi-do (KR)

(21) Appl. No.: 18/849,061

(22) PCT Filed: Mar. 31, 2023
(86) PCT No.: PCT/KR2023/004393

§ 371 Date: Sep. 20, 2024

(30) Foreign Application Priority Data
Apr. 8, 2022 (KR) 10-2022-0043959

(51) Int. Cl. H04W 76/20; H04W 76/15; H04W 88/08

(52) U.S. Cl. CPC H04W 76/20; H04W 76/15; H04W 88/08

(57) ABSTRACT

The present disclosure relates to a 5G or 6G communication system for supporting a higher data transmission rate. The present disclosure provides a method performed by an integrated access and backhaul (IAB) node in a wireless communication system, the method comprising the steps of: identifying whether or not a signaling radio bearer (SRB) 3 is established; and if the SRB3 is established, transmitting an IABotherinformation message to a secondary node (SN) via the SRB3, and if the SRB3 is not established, transmitting, to a master node (MN) via an SRB1, a radio resource control (RRC) message including the IABotherinformation message.

### TECHNICAL FIELD

The disclosure relates to a communication method in a wireless communication system and, particularly, to an integrated access and backhaul (IAB) node.

### BACKGROUND ART

5G mobile communication technologies define broad frequency bands to enable high transmission rates and new services, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (e.g., 95 GHz to 3 THz bands) in order to accomplish transmission rates fifty times faster than 5G mobile communication technologies and ultra-low latencies one-tenth of 5G mobile communication technologies.

At the beginning of 5G mobile communication technologies, in order to support services and to satisfy performance requirements in connection with enhanced Mobile BroadBand (eMBB), Ultra Reliable & Low Latency Communications (URLLC), and massive Machine-Type Communications (mMTC), there has been ongoing standardization regarding beamforming and massive MIMO for alleviating radio-wave path loss and increasing radio-wave transmission distances in mmWave, numerology (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large-capacity data transmission and a polar code for highly reliable transmission of control information, L2 pre-processing, and network slicing for providing a dedicated network customized to a specific service.

Currently, there are ongoing discussions regarding improvement and performance enhancement of initial 5G mobile communication technologies in view of services to be supported by 5G mobile communication technologies, and there has been physical layer standardization regarding technologies such as Vehicle-to-everything (V2X) for aiding driving determination by autonomous vehicles based on information regarding positions and states of vehicles transmitted by the vehicles and for enhancing user convenience, New Radio Unlicensed (NR-U) aimed at system operations conforming to various regulation-related requirements in unlicensed bands, NR UE Power Saving, Non-Terrestrial Network (NTN) which is UE-satellite direct communication for securing coverage in an area in which communication with terrestrial networks is unavailable, and positioning.

Moreover, there has been ongoing standardization in wireless interface architecture/protocol fields regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service fields regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

If such 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with eXtended Reality (XR) for efficiently supporting Augmented Reality (AR), Virtual Reality (VR), Mixed Reality (MR), etc., 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for securing coverage in terahertz bands of 6G mobile communication technologies, Full Dimensional MIMO (FD-MIMO), multi-antenna transmission technologies such as array antennas and large-scale antennas, metamaterial-based lenses and antennas for improving coverage of terahertz band signals, high-dimensional space multiplexing technology using Orbital Angular Momentum (OAM), and Reconfigurable Intelligent Surface (RIS), but also full-duplex technology for increasing frequency efficiency of 6G mobile communication technologies and improving system networks. AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

With the advance of mobile communication systems as described above, various services can be provided, and accordingly there is a need for ways to effectively provide these services, in particular, ways to provide methods for efficient integrated access and backhaul node control.

### DISCLOSURE OF INVENTION

### Technical Problem

Disclosed embodiments are to provide a device and a method capable of efficiently providing services in a mobile communication system.

### Solution to Problem

According to an embodiment of the disclosure, a method performed by an integrated access and backhaul (IAB) node in a wireless communication system may include: identifying whether a signaling radio bearer (SRB) 3 has been established; and when the SRB3 has been established, transmitting an IABotherinformation message to a secondary node (SN) via the SRB3, and when no SRB3 has been established, transmitting a radio resource control (RRC) message including the IABotherinformation message to a master node (MN) via an SRB1, wherein the SN includes a donor node.

The IAB node may operate in new radio dual connectivity (NR-DC).

The IABotherinformation message may be used to request assignment of an Internet protocol (IP) address of the IAB node or to report an IP address of the IAB node.

The RRC message may include a ULInformationTransferMRDC message.

The IABotherinformation message within the ULInformationTransferMRDC message may be transferred to the SN.

According to an embodiment of the disclosure, a method performed by a secondary node (SN) in a wireless communication system may include: receiving, from an integrated access and backhaul (IAB)node, an IABotherinformation message for requesting Internet protocol (IP) address assignment; and configuring an IP address of the IAB node, wherein the receiving, from the IAB node, the IABotherinformation message for requesting Internet protocol (IP) address assignment includes receiving the IABotherinformation message via a signaling radio bearer (SRB) 3 when the SRB3 has been established, and receiving the IABotherinformation message via a master node (MN) when no SRB3 has been established, and wherein the SN is a donor node.

The MN, the SN, and the IAB nodes may be connected with new radio dual connectivity (NR-DC).

The IABotherinformation message received via the MN may be transferred from the IAB node via an SRB1.

The IABotherinformation message received via the SRB1 may be included in a radio resource control (RRC) message, and the RRC message may include a ULInformationTransferMRDC message.

The IABotherinformation message may be used to report the assigned IP address of the IAB node.

According to an embodiment of the disclosure, an integrated access and backhaul (IAB) node in a wireless communication system may include a transceiver and at least one processor, wherein the at least one processor is configured to: identify whether a signaling radio bearer (SRB) 3 has been established; and when the SRB3 has been established, transmit an IABotherinformation message to a secondary node (SN) via the SRB3, and when no SRB3 has been established, transmit a radio resource control (RRC) message including the IABotherinformation message to a master node (MN) via an SRB1, wherein the SN is a donor node.

The IAB node may operate in new radio dual connectivity (NR-DC).

The RRC message may include a ULInformationTransferMRDC message.

The IABotherinformation message within the ULInformationTransferMRDC message may be transferred to the SN.

According to an embodiment of the disclosure, a secondary node (SN) in a wireless communication system may include a transceiver and at least one processor, wherein the at least one processor is configured to: receive, from an integrated access and backhaul (IAB) node, an IABotherinformation message for requesting Internet protocol (IP) address assignment; configure an IP address of the IAB node; and when a signaling radio bearer (SRB) 3 has been established, receive the IABotherinformation message via the SRB3, and when no SRB3 has been established, receive the IABotherinformation message via a master node (MN), and wherein the SN is a donor node.

### Advantageous Effects of Invention

Disclosed embodiments provide a device and a method capable of efficiently providing services in a mobile communication system.

### BRIEF DESCRIPTION OF DRAWINGS

FIG. 1 illustrates a structure of an LTE system according to an embodiment of the disclosure.

FIG. 2 illustrates a radio protocol structure of an LTE system according to an embodiment of the disclosure.

FIG. 3 illustrates a structure of a next-generation mobile communication system according to an embodiment of the disclosure.

FIG. 4 illustrates a radio protocol structure of a next-generation mobile communication system according to an embodiment of the disclosure.

FIG. 5 is a block diagram illustrating a structure of a UE according to an embodiment of the disclosure:

FIG. 6 is a block diagram illustrating a structure of an NR base station according to an embodiment of the disclosure;

FIG. 7 is a diagram for illustrating an operation of transferring an IABOtherInformation message in CP/UP split scenario 1, that is, a case where a donor node is an SN and a non-donor node is an MN according to an embodiment of the disclosure;

FIG. 8 is a diagram for illustrating an operation of transferring an IABOtherInformation message in CP/UP split scenario 2, that is, a case where a donor node is an MN and a non-donor node is an SN according to an embodiment of the disclosure;

FIG. 9 is a diagram for illustrating an operation of transferring an IABOtherInformation message in a CP redundancy case, that is, a case where two separate donors correspond to an MN and an SN of an IAB node, respectively, according to an embodiment of the disclosure; and

FIG. 10 is a flowchart for illustrating an operation of transferring an IABOtherInformation message according to an embodiment of the disclosure.

### MODE FOR THE INVENTION

Hereinafter, the operation principle of the disclosure will be described in detail in conjunction with the accompanying drawings. In describing the disclosure below, a detailed description of known functions or configurations incorporated herein will be omitted when it is determined that the description may make the subject matter of the disclosure unnecessarily unclear. The terms which will be described below are terms defined in consideration of the functions in the disclosure, and may be different according to users, intentions of the users, or customs. Therefore, the definitions of the terms should be made based on the contents throughout the specification.

In the following description, terms for identifying access nodes, terms referring to network entities, terms referring to messages, terms referring to interfaces between network entities, terms referring to various identification information, and the like are illustratively used for the sake of descriptive convenience. Therefore, the disclosure is not limited by the terms as described below, and other terms referring to subjects having equivalent technical meanings may also be used.

In the following description of the disclosure, terms and names defined in in the 3rd generation partnership project long term evolution (3GPP LTE) standards will be used for the sake of descriptive convenience. However, the disclosure is not limited by these terms and names, and may be applied in the same way to systems that conform other standards.

The advantages and features of the disclosure and ways to achieve them will be apparent by making reference to embodiments as described below in detail in conjunction with the accompanying drawings. However, the disclosure is not limited to the embodiments set forth below, but may be implemented in various different forms. The following embodiments are provided only to completely disclose the disclosure and inform those skilled in the art of the scope of the disclosure, and the disclosure is defined only by the scope of the appended claims. Throughout the specification, the same or like reference signs indicate the same or like elements.

Herein, it will be understood that each block of the flowchart illustrations, and combinations of blocks in the flowchart illustrations, can be implemented by computer program instructions. These computer program instructions can be provided to a processor of a general-purpose computer, special purpose computer, or other programmable data processing apparatus to produce a machine, such that the instructions, which execute via the processor of the computer or other programmable data processing apparatus, create means for implementing the functions specified in the flowchart block or blocks. These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Furthermore, each block in the flowchart illustrations may represent a module, segment, or portion of code, which includes one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

As used in embodiments of the disclosure, the “unit” refers to a software element or a hardware element, such as a Field Programmable Gate Array (FPGA) or an Application Specific Integrated Circuit (ASIC), which performs a predetermined function. However, the “unit” does not always have a meaning limited to software or hardware. The “unit” may be constructed either to be stored in an addressable storage medium or to execute one or more processors. Therefore, the “unit” includes, for example, software elements, object-oriented software elements, class elements or task elements, processes, functions, properties, procedures, sub-routines, segments of a program code, drivers, firmware, micro-codes, circuits, data, database, data structures, tables, arrays, and parameters. The elements and functions provided by the “unit” may be either combined into a smaller number of elements, or a “unit”, or divided into a larger number of elements, or a “unit”. Moreover, the elements and “units” may be implemented to reproduce one or more CPUs within a device or a security multimedia card. Furthermore, the “unit” in embodiments may include one or more processors.

In describing the disclosure below, a detailed description of known functions or configurations incorporated herein will be omitted when it is determined that the description may make the subject matter of the disclosure unnecessarily unclear. Hereinafter, embodiments of the disclosure will be described with reference to the accompanying drawings.

In the following description, terms for identifying access nodes, terms referring to network entities, terms referring to messages, terms referring to interfaces between network entities, terms referring to various identification information, and the like are illustratively used for the sake of descriptive convenience. Therefore, the disclosure is not limited by the terms as described below, and other terms referring to subjects having equivalent technical meanings may also be used. For example, the term “terminal” as used in the following description may refer to an MAC entity in a terminal that exists in each of a master cell group (MCG) and a secondary cell group (SCG).

In the following description of the disclosure, terms and names defined in in the 3rd generation partnership project long term evolution (3GPP LTE) standards will be used for the sake of descriptive convenience. However, the disclosure is not limited by these terms and names, and may be applied in the same way to systems that conform other standards.

In the following description, a base station is an entity that allocates resources to terminals, and may be at least one of a gNode B, an eNode B, a Node B, a base station (BS), a wireless access unit, a base station controller, and a node on a network. A terminal may include a user equipment (UE), a mobile station (MS), a cellular phone, a smartphone, a computer, or a multimedia system capable of performing a communication function. Of course, examples of the base station and the terminal are not limited to those mentioned above.

In addition, the disclosure may be applied to intelligent services (e.g., smart homes, smart buildings, smart cities, smart cars or connected cars, healthcare, digital education, retail business, security and safety-related services, etc.) on the basis of 5G communication technology and IoT-related technology. In the disclosure, the term “eNB” may be interchangeably used with the term “gNB” for the sake of descriptive convenience. That is, a base station described as “eNB” may refer to “gNB”. In addition, the term “terminal” may refer to not only mobile phones, NB-IoT devices, and sensors, but also any other wireless communication devices.

A wireless communication system is advancing to a broadband wireless communication system for providing high-speed and high-quality packet data services using communication standards, such as high-speed packet access (HSPA) of 3GPP, LTE (long-term evolution or evolved universal terrestrial radio access (E-UTRA)), LTE-Advanced (LTE-A), LTE-Pro, high-rate packet data (HRPD) of 3GPP2, ultra-mobile broadband (UMB). IEEE 802.16e, and the like, as well as typical voice-based services.

As a typical example of the broadband wireless communication system, an LTE system employs an orthogonal frequency division multiplexing (OFDM) scheme in a downlink (DL) and employs a single carrier frequency division multiple access (SC-FDMA) scheme in an uplink (UL). The uplink refers to a radio link via which a user equipment (UE) or a mobile station (MS) transmits data or control signals to a base station (BS) or eNode B, and the downlink refers to a radio link via which the base station transmits data or control signals to the UE. The above multiple access scheme separates data or control information of respective users by allocating and operating time-frequency resources for transmitting the data or control information for each user so as to avoid overlapping each other, that is, so as to establish orthogonality.

Since a 5G communication system, which is a post-LTE communication system, must freely reflect various requirements of users, service providers, and the like, services satisfying various requirements must be supported. The services considered in the 5G communication system include enhanced mobile broadband (eMBB) communication, massive machine-type communication (mMTC), ultra-reliability low-latency communication (URLLC), and the like.

According to some embodiments, eMBB may aim at providing a data rate higher than that supported by existing LTE, LTE-A, or LTE-Pro. For example, in the 5G communication system, eMBB must provide a peak data rate of 20 Gbps in the downlink and a peak data rate of 10 Gbps in the uplink for a single base station. Furthermore, the 5G communication system must provide an increased user-perceived data rate to the UE, as well as the maximum data rate. In order to satisfy such requirements, transmission/reception technologies including a further enhanced multi-input multi-output (MIMO) transmission technique may be required to be improved. In addition, the data rate required for the 5G communication system may be obtained using a frequency bandwidth more than 20 MHz in a frequency band of 3 to 6 GHz or 6 GHz or more, instead of transmitting signals using a transmission bandwidth up to 20 MHz in a band of 2 GHz used in LTE.

In addition, mMTC is being considered to support application services such as the Internet of Things (IoT) in the 5G communication system, mMTC may have requirements, such as support of connection of a large number of UEs in a cell, enhancement coverage of UEs, improved battery time, a reduction in the cost of a UE, and the like, in order to effectively provide the Internet of Things. Since the Internet of Things provides communication functions while being provided to various sensors and various devices, it must support a large number of UEs (e.g., 1.000,000 UEs/km²) in a cell. In addition, the UEs supporting mMTC may require wider coverage than those of other services provided by the 5G communication system because the UEs are likely to be located in a shadow area, such as a basement of a building, which is not covered by the cell due to the nature of the service. The UE supporting mMTC must be configured to be inexpensive, and may require a very long battery life-time such as 10 to 15 years because it is difficult to frequently replace the battery of the UE.

Lastly, URLLC, which is a cellular-based mission-critical wireless communication service, may be used for remote control for robots or machines, industrial automation, unmanned aerial vehicles, remote health care, emergency alert, and the like. Thus, URLLC must provide communication with ultra-low latency and ultra-high reliability. For example, a service supporting URLLC must satisfy an air interface latency of less than 0.5 ms, and may also require a packet error rate of 10⁻⁵ or less. Therefore, for the services supporting URLLC, a 5G system must provide a transmit time interval (TTI) shorter than those of other services, and may also require a design for assigning a large number of resources in a frequency band in order to secure reliability of a communication link.

The above three services considered in the 5G communication system, that is, eMBB, URLLC, and mMTC, may be multiplexed and transmitted in a single system. In this case, different transmission/reception techniques and transmission/reception parameters may be used between services in order to satisfy different requirements of the respective services. However, mMTC, URLLC, and eMBB as described above are merely an example of different types of services, and service types to which the disclosure is applied are not limited to those mentioned above.

In the following description of embodiments of the disclosure, LTE, LTE-A, LTE Pro, or 5G (or NR, next-generation mobile communication) systems will be described by way of example, but the embodiments of the disclosure may be applied to other communication systems having similar backgrounds or channel types. In addition, based on determinations by those skilled in the art, the embodiments of the disclosure may be applied to other communication systems through some modifications without significantly departing from the scope of the disclosure.

The disclosure proposes a method of transferring, in a dual connectivity situation, an IP address in distributed unit (DU) part configuration information of an integrated access and backhaul (IAB) node of an IAB system.

According to an embodiment of the disclosure, a node of the integrated access and backhaul system may transmit and receive an IP address required by its own distributed unit (DU) to or from a central unit (CU) of a donor node by using a wireless connection of a master node (MN) or a secondary node (SN) in a dual connection.

In the disclosed embodiments, by transmitting an IP address assignment request and an address assignment report signal of a node of an integrated access and backhaul system with respect to various DC architectures, operations of the IAB node may be realized.

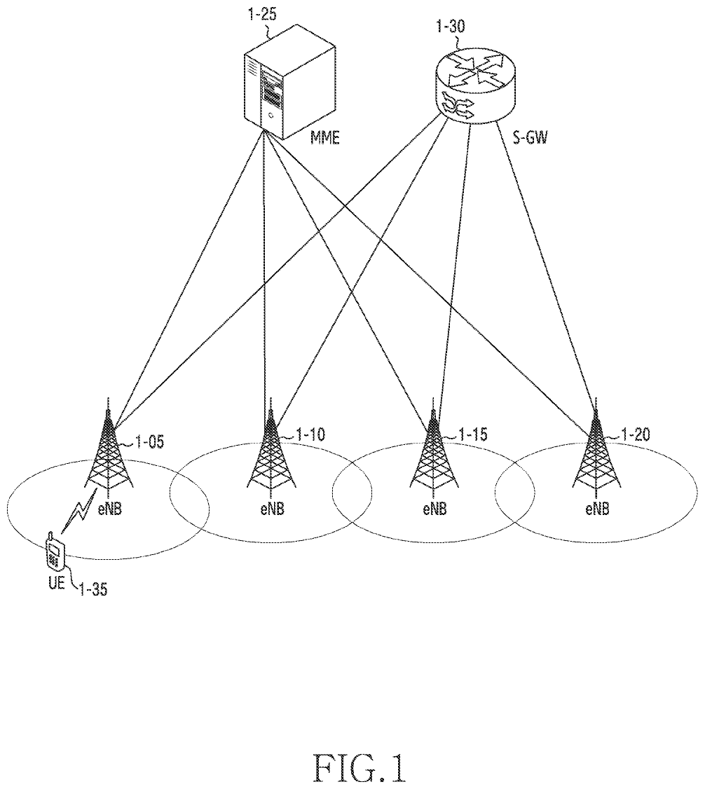

FIG. 1 illustrates a structure of an LTE system according to an embodiment of the disclosure.

Referring to FIG. 1, as illustrated therein, a radio access network of an LTE system may include next-generation base stations (evolved node Bs, hereinafter ENBs, node Bs, or base stations) 1a-05, 1a-10, 1a-15, and 1a-20, a mobility management entity (MME) 1a-25, and a serving gateway (S-GW) 1a-30. A user equipment (hereinafter UE or terminal) 1a-35 may access an external network through the ENBs 1a-05 to 1a-20 and the S-GW 1a-30.

In FIG. 1, the ENBs 1a-05 to 1a-20 may correspond to conventional node Bs of a universal mobile telecommunication system (UMTS). The ENBs may be connected to the UE 1a-35 through a radio channel, and perform more complicated roles than the conventional node Bs. In the LTE system, since all user traffic including real-time services, such as voice over IP (VoIP) via the Internet protocol, may be serviced through a shared channel Thus, a device that collects state information, such as buffer states, available transmit power states, and channel states of UEs, and performs scheduling accordingly is required, and the ENBs 1a-05 to 1a-20 may serve as the device. In general, one ENB may control multiple cells. For example, in order to implement a transfer rate of 100 Mbps, the LTE system may use orthogonal frequency division multiplexing (OFDM) as a radio access technology in a bandwidth of, for example, 20 MHz. Of course, the example given above is not limiting. Furthermore, the ENBs 1a-05 to 1a-20 may employ an adaptive modulation & coding (hereinafter referred to as AMC) scheme for determining a modulation scheme and a channel coding rate according to a channel state of a UE. The serving gateway (S-GW) 1a-30 is a device that provides a data bearer, and may generate or remove a data bearer under the control of the mobility management entity (MME) 1a-25. The MME is a device responsible for various control functions as well as a mobility management function for a UE, and may be connected to multiple base stations.

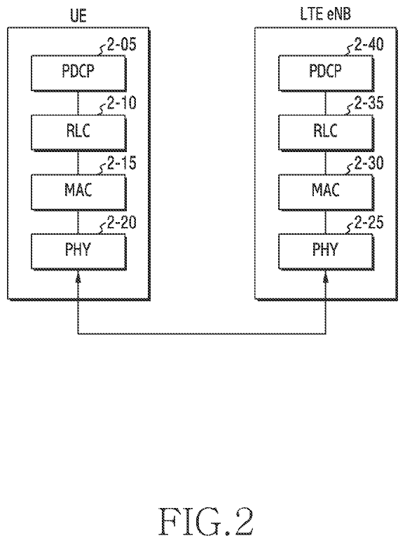

FIG. 2 illustrates a radio protocol structure of an LTE system according to an embodiment of the disclosure.

Referring to FIG. 2, a radio protocol of an LTE system may include a packet data convergence protocol (PDCP) 2-05 or 2-40, a radio link control (RLC) 2-10 or 2-35, a medium access control (MAC) 2-15 or 2-30, and a physical layer 2-20 or 2-25 on each of UE and ENB sides. Of course, the radio protocol of the LTE system may include a larger or smaller number of layers than the structure illustrated in FIG. 2.

According to an embodiment of the disclosure, the PDCP 2-05 or 2-40 may serve to perform operations, such as IP header compression/reconstruction. The main functions of the PDCP 2-05 or 2-40 may be summarized as follows. Obviously, the examples given below are not limiting. Obviously, the examples given below are not limiting.
Header compression and decompression: robust header compression (ROHC) only
Transfer of user data
In-sequence delivery of upper layer PDUs at PDCP re-establishment procedure for RLC acknowledged mode (AM)
For split bearers in DC (only support for RLC AM): PDCP PDU routing for transmission and PDCP PDU reordering for reception
Duplicate detection of lower layer SDUs at PDCP re-establishment procedure for RLC AM
Retransmission of PDCP SDUs at handover and, for split bearers in DC, of PDCP PDUs at PDCP data-recovery procedure, for RLC AM
Ciphering and deciphering
Timer-based SDU discard in uplink

According to an embodiment of the disclosure, the radio link control (RLC) 2-10 or 2-35 may reconfigure a PDCP protocol data unit (PDU) into an appropriate size to perform an ARQ operation. The main functions of the RLC may be summarized as follows. Obviously, the examples given below are not limiting.
Transfer of upper layer PDUs
Error Correction through ARQ (only for AM data transfer)
Concatenation, segmentation and reassembly of RLC SDUs (only for UM and AM data transfer)
Re-segmentation of RLC data PDUs (only for AM data transfer)
Reordering of RLC data PDUs (only for UM and AM data transfer)
Duplicate detection (only for UM and AM data transfer)
Protocol error detection (only for AM data transfer)
RLC SDU discard (only for UM and AM data transfer)
RLC re-establishment

According to an embodiment of the disclosure, the MAC 2-15 or 2-30 may be connected to several RLC layer devices configured in a single terminal, and multiplex RLC PDUs to a MAC PDU and demultiplex a MAC PDU to RLC PDUs. The main functions of the MAC 2-15 or 2-30 are summarized as follows. Obviously, the examples given below are not limiting.
Mapping between logical channels and transport channels
Multiplexing/demultiplexing of MAC SDUs belonging to one or different logical channels into/from transport blocks (TB) delivered to/from the physical layer on transport channels
Scheduling information reporting
Error correction through HARQ
Priority handling between logical channels of one UE
Priority handling between UEs by means of dynamic scheduling
MBMS service identification
Transport format selection
Padding

According to an embodiment of the disclosure, the physical layer 2-20 or 2-25 may perform operations of channel-coding and modulating upper layer data, thereby obtaining OFDM symbols, and delivering the same through a radio channel, or demodulating OFDM symbols received through the radio channel, channel-decoding the same, and delivering the same to the upper layer. Obviously, the examples given below are not limiting.

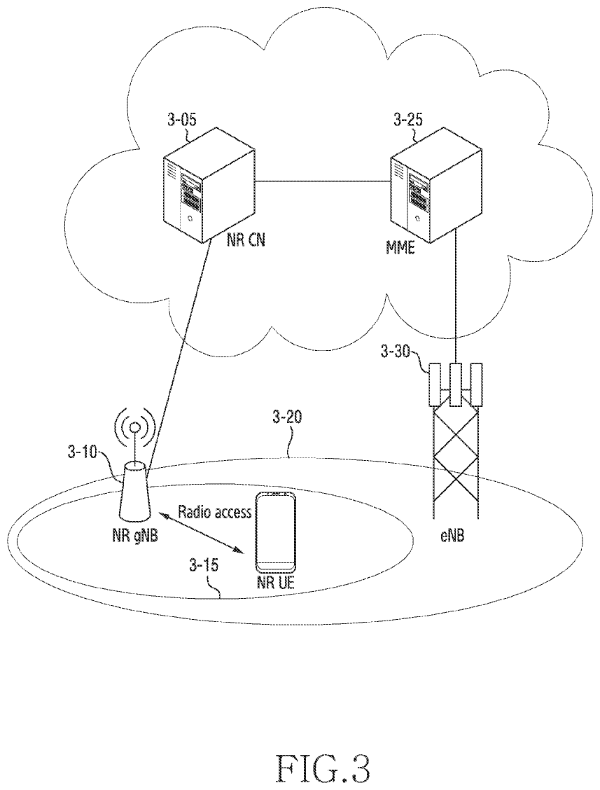

FIG. 3 illustrates a structure of a next-generation mobile communication system according to an embodiment of the disclosure.

Referring to FIG. 3, a radio access network of a next-generation mobile communication system (hereinafter NR or 5G) may include a new radio node B (hereinafter NR gNB or NR base station) 3-10, and a new radio core network (NR CN) 3-05. A new radio user equipment (NR UE or NR terminal) 3-15 may access an external network via the NR gNB 3-10 and the NR CN 3-05.

In FIG. 3, the NR gNB 3-10 may correspond to an evolved node B (eNB) of a conventional LTE system. The NR gNB may be connected to the NR UE 3-15 through a radio channel and provide outstanding services as compared to a conventional node B. In the next-generation mobile communication system, since all user traffic may be serviced through a shared channel. Thus, a device that collects state information, such as buffer states, available transmit power states, and channel states of UEs, and performs scheduling accordingly is required, and the NR gNB 3-10 may serve as the device. In general, one NR gNB may control multiple cells.

According to an embodiment of the disclosure, in order to implement ultrahigh-speed data transfer beyond the current LTE, the next-generation mobile communication system may provide a wider bandwidth than the existing maximum bandwidth. In addition, the next-generation mobile communication system may employ an orthogonal frequency division multiplexing (OFDM) as a radio access technology, and additionally use a beamforming technology.

Furthermore, according to an embodiment of the disclosure, the NR gNB may employ an adaptive modulation & coding (hereinafter referred to as AMC) scheme for determining a modulation scheme and a channel coding rate according to a channel state of a UE. The NR CN 3-05 may perform functions such as mobility support, bearer configuration, and QoS configuration. The NR CN 3-05 is a device responsible for various control functions as well as a mobility management function for a UE, and may be connected to multiple base stations. In addition, the next-generation mobile communication system may interwork with the existing LTE system, and the NR CN 3-05 may be connected to an MME 3-25 via a network interface. The MME 3-25 may be connected to an eNB 3-30 that is an existing base station.

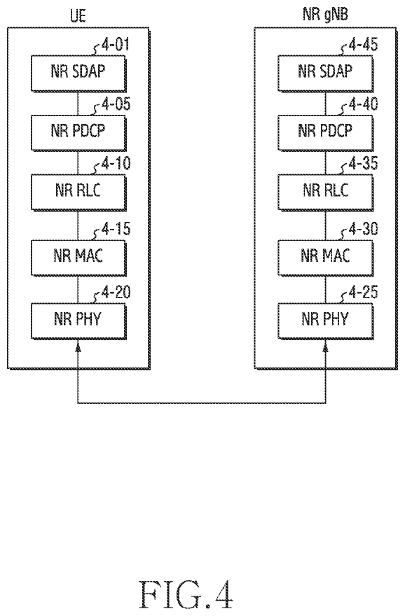

FIG. 4 illustrates a radio protocol structure of a next-generation mobile communication system according to an embodiment of the disclosure.

Referring to FIG. 4, a radio protocol of a next-generation mobile communication system may include an NR service data adaptation protocol (SDAP) layer 4-01 or 4-45, an NR PDCP layer 4-05 or 4-40, an NR RLC layer 4-10 or 4-35, an NR MAC layer 4-15 or 4-30, and an NR PHY layer 4-20 or 4-25 on each of UE and NR base station sides. Of course, the radio protocol of the next-generation mobile communication system may include a larger or smaller number of layers than the structure illustrated in FIG. 4.

According to an embodiment of the disclosure, the main functions of the NR SDAP layer device 4-01 or 4-45 may include some of functions below. Obviously, the examples given below are not limiting.
Transfer of user plane data
Mapping between a QoS flow and a DRB for both DL and UL
Marking QoS flow ID in both DL and UL packets
Reflective QoS flow to DRB mapping for UL SDAP PDUs

With regard to the SDAP layer device 4-01 or 4-45 (hereinafter interchangeably used with layer or layer device), whether to use the header of the SDAP layer device or whether to use functions of the SDAP layer device may be configured for the UE through an RRC message according to each PDCP layer device or according to each bearer or according to each logical channel. Also, if an SDAP header is configured for the SDAP layer device 4-01 or 4-45, the non-access stratum (NAS) quality of service (QoS) reflection configuration 1-bit indicator (NAS reflective QoS) of the SDAP header and the access stratum (AS) QoS reflection configuration 1-bit indicator (AS reflective QoS) may indicate, to the UE, that the UE can update or reconfigure mapping information regarding the QoS flow and data bearer of the uplink and downlink. According to an embodiment, the SDAP header may include QoS flow ID information indicating the QoS. According to an embodiment, the QoS information may be used as data processing priority, scheduling information, etc. for smoothly supporting services.

According to an embodiment of the disclosure, the main functions of the NR PDCP 4-05 or 4-40 may include some of functions below. Obviously, the examples given below are not limiting.
Header compression and decompression: ROHC only
Transfer of user data
In-sequence delivery of upper layer PDUs
Out-of-sequence delivery of upper layer PDUs
PDCP PDU reordering for reception
Duplicate detection of lower layer SDUs
Retransmission of PDCP SDUs
Ciphering and deciphering
Timer-based SDU discard in uplink

Among the above-described functions, the reordering of the NR PDCP layer device 4-05 or 4-40 may refer to a function of reordering PDCP PDU received from a lower layer in an order based on PDCP sequence numbers (SNs). The reordering of the NR PDCP layer device 4-05 or 4-40 may include at least one of a function of transferring data to an upper layer according to a rearranged order, a function of directly transferring data without considering order, a function of rearranging order to record lost PDCP PDUs, a function of reporting the state of lost PDCP PDUs to a transmission side, and a function of requesting retransmission of lost PDCP PDUs.

According to an embodiment of the disclosure, the main functions of the NR RLC layer device 4-10 or 4-35 may include some of functions below. Obviously, the examples given below are not limiting.
Transfer of upper layer PDUs
In-sequence delivery of upper layer PDUs
Out-of-sequence delivery of upper layer PDUs
Error Correction through ARQ
Concatenation, segmentation and reassembly of RLC SDUs
Re-segmentation of RLC data PDUs
Reordering of RLC data PDUs
Duplicate detection
Protocol error detection
RLC SDU discard
RLC re-establishment

Among the above-described functions, the in-sequence delivery of the NR RLC layer device 4-10 or 4-35 may refer to a function of delivering RLC SDUs, received from the lower layer, to the upper layer in sequence. The in-sequence delivery of the NR RLC layer device 4-10 or 4-35 may include a function of, if one original RLC SDU is divided into several RLC SDUs and the RLC SDUs are received, reassembling the several RLC SDUs and transferring the reassembled RLC SDUs.

According to an embodiment of the disclosure, the in-sequence delivery of the NR RLC layer device 4-10 or 4-35 may include at least one of a function of, if one original RLC SDU is segmented into multiple RLC SDUs and the segmented RLC SDUs are received, reassembling the RLC SDUs and delivering the reassembled RLC SDUs, a function of reordering the received RLC PDUs with reference to the RLC sequence number (SN) or PDCP sequence number (SN), a function of recording RLC PDUs lost as a result of reordering, a function of reporting the state of the lost RLC PDUs to the transmitting side, and a function of requesting retransmission of the lost RLC PDUs.

According to an embodiment of the disclosure, the in-sequence delivery of the NR RLC layer device 4-10 or 4-35 may include a function of, if there is a lost RLC SDU, sequentially delivering only RLC SDUs before the lost RLC SDU to the upper layer.

According to an embodiment of the disclosure, the in-sequence delivery of the NR RLC layer device 4-10 or 4-35 may also include a function of, although there is a lost RLC SDU, if a predetermined timer has expired, sequentially transferring all the RLC SDUs received up to the current, to an upper layer.

According to an embodiment of the disclosure, the in-sequence delivery of the NR RLC layer device 4-10 or 4-35 may include a function of, although there is a lost RLC SDU, if a predetermined timer has expired, sequentially delivering, to the upper layer, all the RLC SDUs received up to the current time.

According to an embodiment of the disclosure, the NR RLC layer device 4-10 or 4-35 may process RLC PDUs in a reception sequence, regardless of a sequence based on sequence numbers (out-of-sequence delivery), and then deliver the processed RLC PDUs to the NR PDCP device.

According to an embodiment of the disclosure, upon receiving segments, the NR RLC layer device 4-10 or 4-35 may receive segments stored in a buffer or to be received in the future, reconfigure the segments into one whole RLC PDU, process the RLC PDU, and then deliver the processed RLC PDU to the NR PDCP device.

According to an embodiment of the disclosure, the NR RLC layer device 4-20 or 4-35 may include no concatenation function, which may be performed in the NR MAC layer or replaced with a multiplexing function of the NR MAC layer.

Among the above-described functions, the in-sequence delivery of the NR RLC layer device 4-10 or 4-35 may refer to a function of delivering RLC SDUs, received from the lower layer, to the upper layer in sequence. The out-sequence delivery of the NR RLC layer device 4-10 or 4-35 may include a function of, if one original RLC SDU is segmented into multiple RLC SDUs and the segmented RLC SDUs are received, reassembling the RLC SDUs and delivering the reassembled RLC SDUs. The out-of-sequence delivery function of the NR RLC layer device 4-10 or 4-35 may include a function of storing an RLC sequence number (SN) or a PDCP sequence number (SN) of received RLC PDUs and arranging order to record lost RLC PDUs.

According to an embodiment of the disclosure, the NR MAC layer device 4-20 or 4-30 may be connected to multiple NR RLC layer devices configured in one UE, and the main functions of the NR MAC layer device 4-15 or 4-30 may include some of functions below. Obviously, the examples given below are not limiting.
Mapping between logical channels and transport channels
Multiplexing/demultiplexing of MAC SDUs
Scheduling information reporting
Error correction through HARQ
Priority handling between logical channels of one UE
Priority handling between UEs by means of dynamic scheduling
MBMS service identification
Transport format selection
Padding

According to an embodiment of the disclosure, the NR PHY layer device 4-20 or 4-35 may perform operations of channel-coding and modulating upper layer data, thereby obtaining OFDM symbols, and delivering the same through a radio channel, or demodulating OFDM symbols received through the radio channel, channel-decoding the same, and delivering the same to the upper layer.

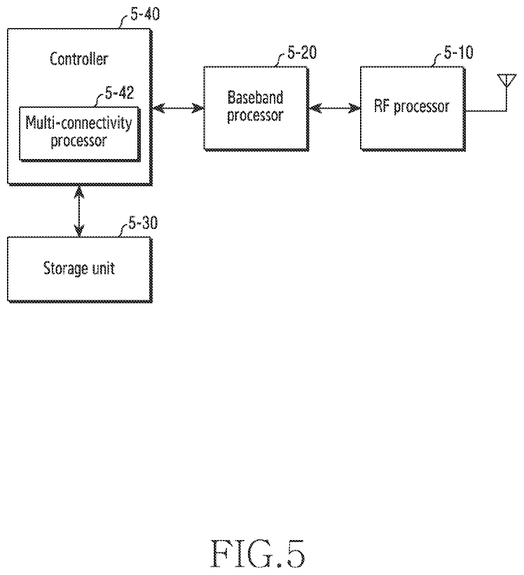

FIG. 5 is a block diagram illustrating a structure of a UE according to an embodiment of the disclosure.

Referring to FIG. 5, a UE may include a radio frequency (RF) processor 5-10, a baseband processor 5-20, a storage unit 5-30, and a controller 5-40. Of course, the disclosure is not limited to the illustration above, and the UE may include more or fewer elements than the elements illustrated in FIG. 5.

The RF processor 5-10 may perform a function for signal transmission and reception via a wireless channel, such as band switching and amplification of a signal. That is, the RF processor 5-10 may up-convert a baseband signal provided from the baseband processor 5-20 into an RF band signal, transmit the converted RF band signal via an antenna, and then down-convert the RF band signal received via the antenna into a baseband signal. For example, the RF processor 5-10 may include a transmission filter, a reception filter, an amplifier, a mixer, an oscillator, a digital-to-analog converter (DAC), an analog-to-digital converter (ADC), and the like. Of course, the disclosure is not limited to the illustration above. In FIG. 5, only one antenna is illustrated, but the UE may have multiple antennas. In addition, the RF processor 5-10 may include multiple RF chains. Additionally, the RF processor 5-10 may perform beamforming. For beamforming, the RF processor 5-10 may adjust phases and magnitudes of respective signals transmitted and received via multiple antennas or antenna elements. In addition, the RF processor 5-10 may perform multi-input multi-output (MIMO), and may receive multiple layers when performing an MIMO operation. The RF processor 5-10 may perform reception beam sweeping by appropriately configuring the multiple antennas or antenna elements under the control of the controller, or may adjust the direction and beam width of a reception beam so that the reception beam is coordinated with a transmission beam.

According to an embodiment of the disclosure, the baseband processor 5-20 may perform a function of conversion between a baseband signal and a bitstream according to physical layer specifications of the system. For example, during data transmission, the baseband processor 5-20 generates complex symbols by encoding and modulating a transmission bitstream. In addition, during data reception, the baseband processor 5-20 may reconstruct a reception bitstream via demodulation and decoding of a baseband signal provided from the RF processor 5-10. For example, when conforming to an orthogonal frequency division multiplexing (OFDM) scheme, during data transmission, the baseband processor 5-20 generates complex symbols by encoding and modulating a transmission bitstream, maps the complex symbols to sub-carriers, and then configures OFDM symbols via an inverse fast Fourier transform (IFFT) operation and cyclic prefix (CP) insertion. In addition, during data reception, the baseband processor 5-20 may divide the baseband signal provided from the RF processor 5-10 in units of OFDM symbols, reconstruct the signals mapped to the sub-carriers via fast Fourier transform (FFT), and then reconstruct the reception bitstream via demodulation and decoding.

According to an embodiment of the disclosure, the baseband processor 5-20 and the RF processor 5-10 transmit and receive signals as described above. The baseband processor 5-20 and the RF processor 5-10 may be referred to as a transmitter, a receiver, a transceiver, or a communication unit. Furthermore, at least one of the baseband processor 5-20 and the RF processor 5-10 may include multiple communication modules to support multiple different radio access technologies. In addition, at least one of the baseband processor 5-20 and the RF processor 5-10 may include different communication modules to process signals of different frequency bands. For example, the different radio access technologies may include a wireless LAN (e.g., IEEE 802.11), a cellular network (e.g., LTE), and the like. In addition, the different frequency bands may include a super-high frequency (SHF) (e.g., 2.NRHz, NRhz) band, and a millimeter (mm) wave (e.g., 60 GHz) band. The UE may transmit signals to and receive signals from a base station by using the baseband processor 2e-20 and the RF processor 2e-10, and the signals may include control information and data. The UE may transmit signals to and receive signals from a base station by using the baseband processor 5-20 and the RF processor 5-10, and the signals may include control information and data.

According to an embodiment of the disclosure, the storage unit 5-30 may store data, such as basic programs, application programs, and configuration information for operation of the UE. Particularly, the storage unit 5-30 may store information related to a second access node that performs wireless communication using a second radio access technology. The storage unit 5-30 provides stored data in response to a request of the controller 5-40. The storage unit 5-30 may include storage media, such as a ROM, a RAM, a hard disk, a CD-ROM, and a DVD, or a combination of the storage media. In addition, the storage unit 5-30 may include multiple memories. In addition, the storage unit 5-30 may include multiple memories. According to an embodiment, the storage unit 5-30 may store a program for performing a method of assigning an IP address in the IAB system described in the disclosure.

The controller 5-40 controls overall operations of the UE. For example, the controller 5-40 transmits or receives a signal via the baseband processor 5-20 and the RF processor 5-10. In addition, the controller 5-40 records and reads data in the storage unit 5-40. To this end, the controller 5-40 may include at least one processor. For example, the controller 5-40 may include a communication processor (CP) configured to perform control for communication and an application processor (AP) configured to control a higher layer, such as an application program. In addition, at least one element within the UE may be implemented in a single chip. In addition, at least one element within the UE may be implemented in a single chip. Additionally, according to an embodiment of the disclosure, the controller 5-40 may include a multi-connectivity processor 5-42 configured to perform processing for operating in a multi-connectivity mode. In addition, the respective elements of the UE may operate to perform embodiments of the disclosure.

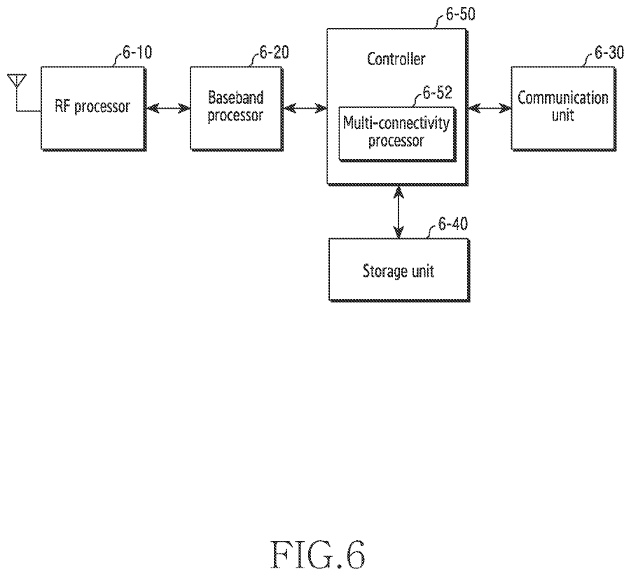

FIG. 6 is a block diagram illustrating a structure of an NR base station according to an embodiment of the disclosure. According to an embodiment of the disclosure, a network entity (or a network function) and an IAB node may have a configuration identical or similar to that of the NR base station of FIG. 6.

Referring to FIG. 6, the base station may include an RF processor 6-10, a baseband processor 6-20, a backhaul communication unit 6-30, a storage unit 6-40, and a controller 6-50. Of course, the disclosure is not limited to the illustration above, and the base station may include more or fewer elements than the elements illustrated in FIG. 6.

According to an embodiment of the disclosure, the RF processor 6-10 may perform a function for signal transmission and reception via a wireless channel, such as band switching and amplification of a signal. That is, the RF processor 6-10 up-converts a baseband signal provided from the baseband processor 6-20 into an RF band signal, transmits the converted RF band signal via an antenna, and then down-converts the RF band signal received via the antenna into a baseband signal. For example, the RF processor 6-10 may include a transmission filter, a reception filter, an amplifier, a mixer, an oscillator, a DAC, an ADC, and the like. In FIG. 1F, only one antenna is illustrated, but the RF processor 6-10 may have multiple antennas. In addition, the RF processor 6-10 may include multiple RF chains. Additionally, the RF processor 6-10 may perform beamforming. For beamforming, the RF processor 6-10 may adjust phases and magnitudes of respective signals transmitted and received via multiple antennas or antenna elements. The RF processor may perform a downlink MIMO operation by transmitting one or more layers.

According to an embodiment of the disclosure, the baseband processor 6-20 may perform a function of conversion between a baseband signal and a bitstream according to physical layer specifications of a first radio access technology. For example, during data transmission, the baseband processor 6-20 may generate complex symbols by encoding and modulating a transmission bitstream. In addition, during data reception, the baseband processor 6-20 may reconstruct a reception bitstream via demodulation and decoding of a baseband signal provided from the RF processor 6-10. For example, when conforming to an OFDM scheme, during data transmission, the baseband processor 6-20 generates complex symbols by encoding and modulating a transmission bitstream, maps the complex symbols to sub-carriers, and then configures OFDM symbols via an IFFT operation and CP insertion. In addition, during data reception, the baseband processor 6-20 may divide the baseband signal provided from the RF processor 6-10 in units of OFDM symbols, reconstruct the signals mapped to the sub-carriers via an FFT operation, and then reconstruct the reception bitstream via demodulation and decoding. The baseband processor 6-20 and the RF processor 6-10 may transmit and receive signals as described above. Accordingly, the baseband processor 620 and the RF processor 6-10 may be referred to as a transmitter, a receiver, a transceiver, a communication unit, or a wireless communication unit. The base station may transmit signals to and receive signals from a UE by using the baseband processor 6-20 and the RF processor 6-10, and the signals may include control information and data.

According to an embodiment of the disclosure, the communication unit 6-30 provides an interface configured to perform communication with other nodes within a network. That is, the communication unit 6-30 may convert, into a physical signal, a bitstream transmitted from a main base station to another node, for example, an auxiliary base station and a core network, and may convert a physical signal received from another node into a bitstream. The communication unit 6-30 may also be referred to as a backhaul communication unit.

According to an embodiment of the disclosure, the storage unit 6-40 may store data, such as basic programs, application programs, and configuration information for operation of the base station. The storage unit 6-40 may store information on a bearer assigned to a connected UE, a measurement result reported from the connected UE, and the like. Additionally, the storage unit 6-40 may store information serving as a criterion for determining whether to provide the UE with multi-connectivity or to suspend multi-connectivity. The storage unit 6-40 provides stored data in response to a request of the controller 6-50. The storage unit 6-40 may include storage media, such as a ROM, a RAM, a hard disk, a CD-ROM, and a DVD, or a combination of the storage media. In addition, the storage unit 6-40 may include multiple memories. According to an embodiment, the storage unit 6-40 may store a program for performing a method of assigning an IP address in the IAB system described in the disclosure.

According to an embodiment of the disclosure, the controller 6-50 controls overall operations of the base station. For example, the controller 6-50 transmits or receives a signal via the baseband processor 6-20 and the RF processor 6-10 or via the communication unit 6-30. In addition, the controller 6-50 records and reads data in the storage unit 6-40. To this end, the controller 6-50 may include at least one processor. In addition, at least one element within the base station may be implemented in a single chip. In addition, the respective elements of the base station may operate to perform embodiments of the disclosure.

An IP address should be assigned to a distributed unit (DU) of an IAB node. Communication between a central unit (CU) and the DU may be performed based on an IP address. In Rel-16, an IP address is assigned by a donor CU or operation administration maintenance (OAM). According to an RRC operation related to Rel-16, a CU may request an IAB node to inform about address information assigned by OAM, or when OAM has assigned no address, mobile termination (MT) may request assignment from the CU. In an E-UTRAN new radio dual connectivity (EN-DC) situation, an IP address may be transferred using EUTRA ULInformationTransferMRDC. In the disclosure, an operation of transferring an IP address in new radio dual connectivity (NR-DC) is to be described.

In order to assign an IP address to an IAB node in an NR-DC situation, the following messages and fields may be used. Of course, the disclosure is not limited to the following examples.

IABOtherInformation message (UL msg): This may be used when MT of an IAB node requests IP address assignment from a CU or transfers already assigned address information to a donor node.

iab-IP-AddressConfigurationList field in RRCReconfiguration: This is a field used when a CU assigns an IP address to an IAB node.

In addition, the IABOtherinformation message may include the following information.
IPaddress type: This is an indicator indicating IPv6 or IPv4 and may be distinguished for each IP address.
IP address for Non-F1 traffic
IP address for F1-U traffic
IP address for F1-C traffic

According to an embodiment of the disclosure, when an IAB node requests IP address assignment or reports a pre-assigned IP address to a donor node, a method of transmitting an IABOtherInformation message may vary depending on the architecture of a wireless communication system including the IAB node and a type of an established signaling radio bearer (SRB). Of course, the disclosure is not limited to the above example.

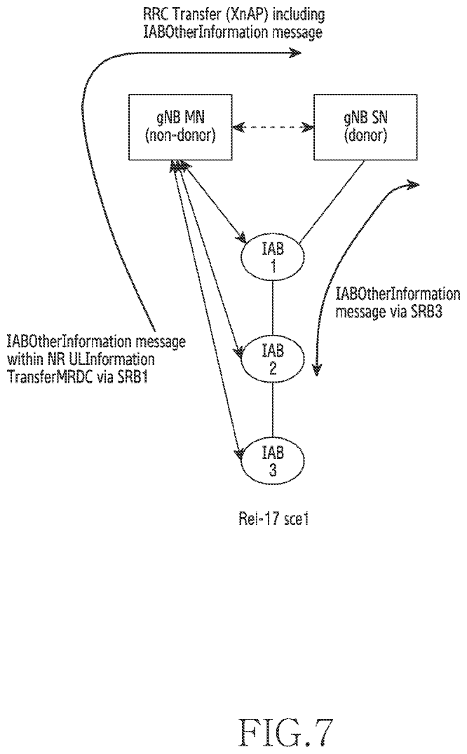

FIG. 7 is a diagram for illustrating an operation of transferring an IABOtherinformation message in CP/UP split scenario 1, that is, a case where a donor node is a secondary node (SN) and a non-donor node is a master node (MN) according to an embodiment of the disclosure.

When an IABOtherInformation message needs to be transmitted, if a donor node is an SN and a non-donor node is an MN, and if a signaling radio bearer 3 (SRB3) has been established for an IAB node, the IAB node may directly transfer the IABOtherInformation message to the SN.

Otherwise, that is, if no SRB3 has been established, the IABOtherInformation message may be included in an NR ULInformationTransferMRDC message of an MCG and transmitted to the MN via an SRB1. After receiving the NR ULInformationTransferMRDC, the MN may identify or extract the IABOtherInformation and transfer the same to the SN via an RRC transfer procedure of an Xn interface.

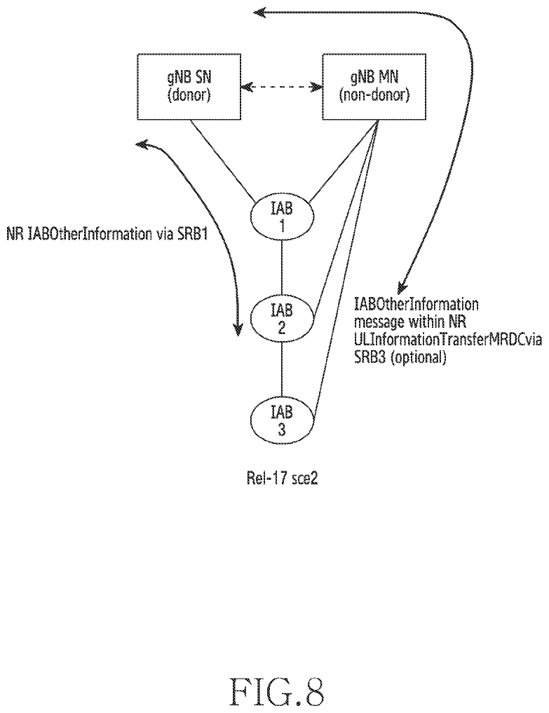

FIG. 8 is a diagram for illustrating an operation of transferring an IABOtherInformation message in CP/UP split scenario 2, that is, a case where a donor node is an MN and a non-donor node is an SN according to an embodiment of the disclosure.

When an IABOtherInformation message needs to be transmitted, if a donor node is an MN and a non-donor node is an SN, and if an SRB1 has been established for an IAB node, and/or the IAB node has received no indicator indicating to use an SRB3 (or split SRB), the IAB node may transfer the IABOtherInformation message to the MN by using the SRB1.

Else, that is, although an SRB1 has been established, if the IAB node has received an indicator indicating to use an SRB3 (or split SRB), the IABOtherinformation message may be included (or encapsulated) in an NR ULInformationTransferMRDC message of a secondary cell group (SCG) and transmitted to the SN via an SCG path of the SRB3 (or split SRB1 or split SRB2). The SN having received the NR ULInformationTransferMRDC message may extract or identify the IABOtherInformation message, and transfer the message to the MN by using an RRC transfer procedure on an Xn interface.

For FIG. 7 and FIG. 8 described above, that is, when only the CP/UP split scenario is considered, it may be necessary to identify which scenario or architecture the IAB node is included in for a procedure of transmitting the IABOtherinformation message by the IAB node (hereinafter, interchangeably used with MT of the IAB node). To this end, the IAB node (mobile termination (MT) of the IAB node) may identify, via the information below, which system architecture the IAB node is included in or which scenario among the aforementioned scenarios of FIG. 7 and FIG. 8 the IAB node is included in.

Opt 1. The IAB node may distinguish an architecture by identifying the position/or presence or absence of a BAP-Config field or an iab-IP-AddressConfig field in an RRCReconfiguration message received by the IAB node. Specifically, the IAB node may perform the following operations.
If an operation condition in ENDC is not satisfied,
   if BAP-Config or IP Add config is included in the received RRCReconfiguration message and the RRCReconfiguration message is received via an SRB3 (scenario 1) (If BAP-Config or IP Add Config is in the received RRCReconfig msg, and this msg is received via SRB3 (scenario 1)),
   the IAB node (MT) transmits the IABOtherInformation message via the SRB3 (MT send IABOtherinformation via SRB3).
   If BAP-Config or IP Add config is included in the received RRCReconfiguration message, and the RRCReconfiguration message is received via an SRB1 by being included (encapsulated) in an mrdc-SecondaryCellGroupConfig field in an MCG RRCReconfiguration message (scenario 1) (Else if BAP-Config or IPAddConfig is in the RRCReconfig msg and this msg is encapsulated in mrdc-SecondaryCellGroupConfig field in MCG RRCReconfiguration message received via SRB1 (scenario 1),
   the IAB node (MT) transmits the IABOtherinformation message via the SRB1 by including (encapsulating) the same in NR ULInformationTransferMRDC (MT send IABOtherInformation via SRB1 encapsulated in NR ULInformationTransferMRDC).
   Else (for scenario 2 or a single connection) (Else (scenario 2/single connection case)),
   the IAB node (MT) transmits the IABOtherinformation message via the SRB1 (MT send IABOtherInformation via SRB1).

Opt 2. The IAB node may identify the architecture of the system, based on whether an RRCReconfiguration message including BAP-Config/IP address config is for (or related to) an MCG or SCG configuration. Specifically, the IAB node may perform the followings.
If the operation condition in ENDC is not satisfied,
if BAP-Config or IP Add config in the RRCReconfiguration message associated with an SCG is received via an SRB3 (If BAP-Config/IP address config in RRCReconfiguration associated with SCG is received via SRB3),
   the IAB node (MT) transmits the IABOtherInformation message via the SRB3 (MT send IABOtherInformation via SRB3).
If BAP-Config or IP Add config in the RRCReconfiguration message associated with the SCG is received via an SRB1 (Else if BAP-Config/IP address config in RRCReconfiguration associated with SCG is received via SRB1),
   the IAB node (MT) transmits the IABOtherinformation message via the SRB1 by including (encapsulating) the same in NR ULInformationTransferMRDC (MT send IABOtherInformation via SRB1 encapsulated in NR ULInformationTransferMRDC).
   Else,
   the IAB node (MT) transmits the IABOtherInformation message via the SRB1 (MT send IABOtherinformation via SRB1).

Opt 3. A donor node may pre-configure or define a method for IABOtherInformation message transmission.

The donor node may transmit at least one piece of the following information to the IAB node via a message on RRCReconfiguration or F1 application protocol (F1AP). The message on RRCReconfiguration or F1AP may include at least one of the following indicators. Of course, the disclosure is not limited to the following examples.
SRB3, SRB1withEncap, and SRB1

If at least one of the indicators described above is received in the message on RRCReconfiguration or F1AP, the IAB node may perform an operation of transferring an IABOtherinformation message, which corresponds to each indicator.
An SRB3 indicator indicates to transfer IABOtherInfo msg via SRB3.
   An SRB1withEncap indicator indicates to transmit an IABOtherInformation message via SRB1 by including (encapsulating) the same in NR ULInformationTransferMRDC.
   An SRB1 indicator indicates to transfer an IABOtherInformation message via SRB1.

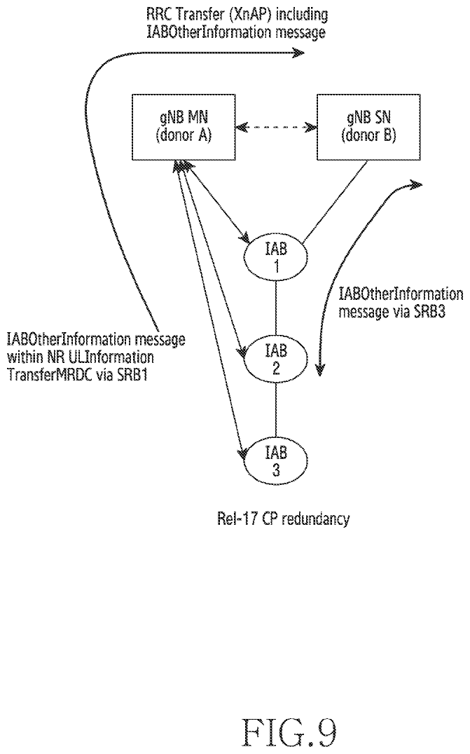

FIG. 9 is a diagram for illustrating an operation of transferring an IABOtherInformation message in a CP redundancy case, that is, a case where two separate donors correspond to an MN and an SN of an IAB node, respectively, according to an embodiment of the disclosure.

A case where two separate donors correspond to an MN and an SN of an IAB node, respectively, may be a case where the two separate donors are associated with both parent nodes of the IAB node. When two separate donors correspond to an MN and an SN of an IAB node, respectively, even if an SRB3 has been established, an RRCReconfiguration message transferred via the SRB3 may not necessarily correspond to the RRCReconfiguration message of scenario 1 (i.e., the case of FIG. 7) of the CP/UP split architecture.

Therefore, a case where two separate donors correspond to an MN and an SN of an IAB node, respectively, is not necessarily a case that the IAB node transmits IABOtherinformation to the SN via an SRB3, but the IAB node may transfer IABOtherInformation to the MN as well as the SN at the same time. Accordingly, an IAB node cannot identify an architecture by an existing method of receiving RRCReconfiguration including BAP-Config/iab-IP-AddressConfigurationList or whether an SRB has been established.

Therefore, when two separate donors correspond to an MN and an SN of an IAB node, respectively, the IAB node (IAB MT) determines, on the basis of a position of a donor node subject to transmission of an IABOtherinformation message to be transmitted, the donor node to transmit the IABOtherInformation node, and transmits the IABOtherinformation message. That is, when requesting IP address assignment from the MN or the SN via the IABOtherinformation message, or reporting an assigned IP address, the IAB node may perform transmission by distinguishing the MN/SN that is a target node, i.e., a cell group of an MCG/SCG.
If an operation condition in ENDC is not satisfied,
[A] if an IAB node (hereinafter, interchangeably used with IAB MT or MT) wants to request an SN or SCG-associated IP address or wants to report an already assigned SN or SCG-associated IP address to an SN donor (or if an IAB node (MT) wants to request an SN (or SCG)-associated IP address or wants to report an SCG-associated IP address to an SN donor) ([A] Else if MT wants to request of SCG associated IP address assignment or report the SCG associated IP address assigned to SN donor (or else if MT wants to request for SN(/SCG) associated IP address assignment or to report IP address associated with SCG to SN donor)),
   if an SRB3 is configured (or established),
   an IABOtherInformation message is transmitted to the SN via the SRB3 (IABOtherinformation is transferred to SN over SRB3), or the IAB node submits, for SN donor transmission, the IABOtherInformation message to a lower layer via the SRB3 (submits the IABOtherinformation message via SRB3 to lower layers for SN donor).
   Else,
      the IABOtherinformation message is included in NR ULinformationTransfer and transmitted to the SN via the MN over an SRB1 (IABOtherinformation is encapsulated in NR ULInformationTransfer and transferred to SN via MN over SRB1), or the IAB node includes the IABOtherInformation message in ULInformationTransferMRDC that is an NR RRC message of an NR MCG and transfers the same to the MN via the SRB1 (submits the IABOtherinformation via the NR MCG embedded in NR RRC message ULInformationTransferMRDC via SRB1 to MN).
[B] Else (That is, when IABOtherInformation is used for reporting to an MN donor and for requesting an MCG associated IP address),
   the IABOtherinformation message is transmitted to the MN via the SRB1 (IABOtherInformation is transferred to MN over SRB1), or in order to transmit the IABOtherInformation message to the MN donor, the IAB node transfers the same to a lower layer via the SRB1 (the IAB MT transfers IABOtherinformation message via SRB1 to lower layers for MN donor).

In the aforementioned operations, the order of operation [A] and operation [B] may be changed. That is, the IAB node identifies that the IABOtherInformation message is used for reporting to the MN donor or for requesting an IP address, and then, if not, the IAB node may identify whether the IABOtherInformation message is used for reporting to the SN donor or for requesting an IP address. That is, the IAB node may operate as follows.
If the operation condition in ENDC is not satisfied,
if an IAB node (MT) wants to request an IP address or wants to report an IP address already assigned from an MN donor (or if an IAB node (MT) wants to request an MN (or MCG)-associated IP address or wants to report an MCG-associated IP address to an MN donor) (Else if MT wants to request of IP address assignment or report the IP address already assigned to MN donor (or else if MT wants to request of MN(/MCG) associated IP address assignment or to report IP address associated with MCG to MN donor)).
   the IABOtherinformation message is transmitted to the MN via an SRB1 (IABOtherinformation is transferred to MN over SRB1).
   Else,
   if an SRB3 is configured (or established),
      the IABOtherInformation message is transmitted to an SN via the SRB3 (IABOtherinformation is transferred to SN over SRB3).
   Else,
      the IABOtherinformation message is included in NR ULinformationTransfer and transmitted to the SN via the MN over the SRB1 (IABOtherInformation is encapsulated in NR ULinformationTransfer and transferred to SN via MN over SRB1).

The aforementioned two embodiments may be operations applicable to all cases regardless of whether the architecture of the IAB node is CP/UP split or not.

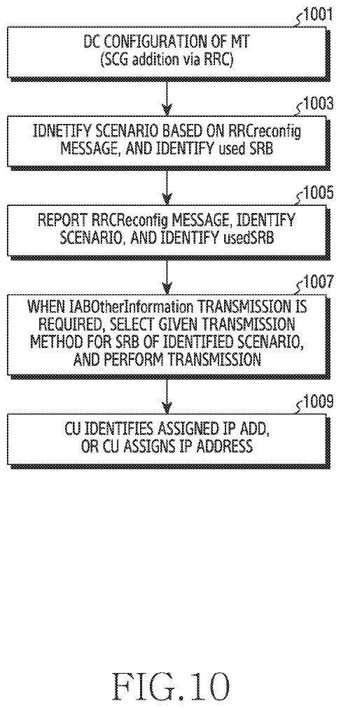

FIG. 10 is a flowchart for illustrating an operation of transferring an IABOtherinformation message according to an embodiment of the disclosure.

In operation 1001, an IAB node (MT) may identify that DC has been configured via an SCG addition procedure.

Then, when the IAB node receives, in operation 1003, configuration information including BAP-Config or iab-IP-AddressConfiguration as IAB-specific configuration information, the IAB node may identify, in operation 1005, a position of a donor node in a DC situation via an SRB in which RRCReconfiguration including BAP-Config or iab-IP-Configuration list fields is transmitted.

For example, as described above, if the RRCReconfiguration including the BAP-Config or iab-IP-Configuration list fields is transmitted as it is (i.e., without being included in another message) via an SRB3, the IAB node may identify that an SN is a donor node. Separately, if the RRCReconfiguration including the BAP-Config or iab-IP-Configuration list fields is included in an mrdc-SecondarvCellConfig field of RRCReconfiguration of an MCG and transferred via an SRB1, the IAB node may identify that an SN is a donor node.

Alternatively, if the RRCReconfiguration including the BAP-Config or iab-IP-Configuration list fields is transmitted as it is (i.e., without being included in another message) via the SRB1, the IAB node may identify that an MN is a donor node.

Since the IAB node is able to identify that only one of the MN and the SN is a donor node at a first time point, and identify again that another node is a donor node at a second time point that is a time point after the first time point, the IAB node may identify both of the system architecture of the aforementioned CP/UP split scenario 1 or 2 and the system architecture of CP redundancy.

After identifying the system architecture, if it is necessary to perform IABOtherInformatoin transmission in operation 1007, the IAB node may determine a donor node to which the IABOtherinformation needs to be transmitted. When the IAB node is to transmit the IABOtherinformation to the determined donor node, the IAB node may use the algorithm in FIG. 9 (when including both CP/UP split 1/2 and CP redundancy) or use the algorithm in FIG. 7 or FIG. 8 (when assuming only CP/UP split 1 or 2).

By transferring the IABOtherInformation message to the required target donor node according to the aforementioned method, the IAB node may transfer assigned IP address information or an IP address assignment request to the determined donor node.

According to the aforementioned operations of the IAB node, in operation 1009, a CU of the donor node may identify the assigned IP address, or the CU may identify an IP address.

According to an embodiment of the disclosure, a method performed by an integrated access and backhaul (IAB) node in a wireless communication system may include: identifying whether a signaling radio bearer (SRB) 3 has been established; and when the SRB3 has been established, transmitting an IABotherinformation message to a secondary node (SN) via the SRB3, and when no SRB3 has been established, transmitting a radio resource control (RRC) message including the IABotherinformation message to a master node (MN) via an SRB1, wherein the SN includes a donor node.

The IAB node may operate in new radio dual connectivity (NR-DC).

The IABotherinformation message may be used to request assignment of an Internet protocol (IP) address of the IAB node or to report an IP address of the IAB node.

The RRC message may include a ULInformationTransferMRDC message.

The IABotherinformation message within the ULInformationTransferMRDC message may be transferred to the SN.

According to an embodiment of the disclosure, a method performed by a secondary node (SN) in a wireless communication system may include: receiving, from an integrated access and backhaul (IAB)node, an IABotherinformation message for requesting Internet protocol (IP) address assignment; and configuring an IP address of the IAB node, wherein the receiving, from the IAB node, the IABotherinformation message for requesting Internet protocol (IP) address assignment includes receiving the IABotherinformation message via a signaling radio bearer (SRB) 3 when the SRB3 has been established, and receiving the IABotherinformation message via a master node (MN) when no SRB3 has been established, and wherein the SN is a donor node.

The MN, the SN, and the IAB nodes may be connected with new radio dual connectivity (NR-DC).

The IABotherinformation message received via the MN may be transferred from the IAB node via an SRB1.

The IABotherinformation message received via the SRB1 may be included in a radio resource control (RRC) message, and the RRC message may include a ULInformationTransferMRDC message.

The IABotherinformation message may be used to report the assigned IP address of the IAB node.

According to an embodiment of the disclosure, an integrated access and backhaul (IAB) node in a wireless communication system may include a transceiver and at least one processor, wherein the at least one processor is configured to: identify whether a signaling radio bearer (SRB) 3 has been established; and when the SRB3 has been established, transmit an IABotherinformation message to a secondary node (SN) via the SRB3, and when no SRB3 has been established, transmit a radio resource control (RRC) message including the IABotherinformation message to a master node (MN) via an SRB1, wherein the SN is a donor node.

The IAB node may operate in new radio dual connectivity (NR-DC).

The RRC message may include a ULInformationTransferMRDC message.

The IABotherinformation message within the ULInformationTransferMRDC message may be transferred to the SN.

According to an embodiment of the disclosure, a secondary node (SN) in a wireless communication system may include a transceiver and at least one processor, wherein the at least one processor is configured to: receive, from an integrated access and backhaul (IAB) node, an IABotherinformation message for requesting Internet protocol (IP) address assignment; configure an IP address of the IAB node; and when a signaling radio bearer (SRB) 3 has been established, receive the IABotherinformation message via the SRB3, and when no SRB3 has been established, receive the IABotherinformation message via a master node (MN), and wherein the SN is a donor node.

Methods disclosed in the claims and/or methods according to the embodiments described in the specification of the disclosure may be implemented by hardware, software, or a combination of hardware and software.

When the methods are implemented by software, a computer-readable storage medium for storing one or more programs (software modules) may be provided. The one or more programs stored in the computer-readable storage medium may be configured for execution by one or more processors within the electronic device. The at least one program includes instructions that cause the electronic device to perform the methods according to various embodiments of the disclosure as defined by the appended claims and/or disclosed herein.

These programs (software modules or software) may be stored in non-volatile memories including a random access memory and a flash memory, a read only memory (ROM), an electrically erasable programmable read only memory (EEPROM), a magnetic disc storage device, a compact disc-ROM (CD-ROM), digital versatile discs (DVDs), or other type optical storage devices, or a magnetic cassette. Alternatively, any combination of some or all of them may form a memory in which the program is stored. In addition, a plurality of such memories may be included in the electronic device.

Furthermore, the programs may be stored in an attachable storage device which can access the electronic device through communication networks such as the Internet, Intranet. Local Area Network (LAN), Wide LAN (WLAN), and Storage Area Network (SAN) or a combination thereof. Such a storage device may access the electronic device via an external port. Also, a separate storage device on the communication network may access a portable electronic device.

In the above-described detailed embodiments of the disclosure, an element included in the disclosure is expressed in the singular or the plural according to presented detailed embodiments. However, the singular form or plural form is selected appropriately to the presented situation for the convenience of description, and the disclosure is not limited by elements expressed in the singular or the plural. Therefore, either an element expressed in the plural may also include a single element or an element expressed in the singular may also include multiple elements.

The embodiments of the disclosure described and shown in the specification and the drawings are merely specific examples that have been presented to easily explain the technical contents of the disclosure and help understanding of the disclosure, and are not intended to limit the scope of the disclosure. That is, it will be apparent to those skilled in the art that other variants based on the technical idea of the disclosure may be implemented. Also, the above respective embodiments may be employed in combination, as necessary. For example, a part of one embodiment of the disclosure may be combined with a part of another embodiment to operate a base station and a terminal. In addition, the embodiments of the disclosure may be applied to other communication systems and other variants based on the technical idea of the embodiments may also be implemented.

1-15. (canceled)

16. A method performed by an integrated access and backhaul (IAB) node in a wireless communication system, the method comprising:
in case that an IAB-mobile terminal (MT) node performs an Internet protocol (IP) address-related procedure for an IAB-donor central unit (CU) in a secondary node (SN), identifying whether a signaling radio bearer (SRB) 3 is configured;
in case that the SRB3 is configured, transmitting an IABotherinformation message to the SN via the SRB3;
in case that the SRB3 is not configured, transmitting a radio resource control (RRC) message comprising the IABotherinformation message to a master node (MN); and
in case that the IAB-MT node performs the IP address-related procedure for an IAB-donor CU in the MN, providing the IABotherinformation message to a lower layer.

17. The method of claim 16, wherein the IAB-MT node operates in new radio dual connectivity (NR-DC).

18. The method of claim 16, wherein the IP address-related procedure comprises requesting an IP address of the IAB-MT node or reporting the IP address of the IAB-MT node.

19. The method of claim 16, wherein the RRC message comprises a ULInformationTransferMRDC message.

20. The method of claim 19, wherein the IABotherinformation message within the ULInformationTransferMRDC message is transferred to the SN.

21. A method performed by a secondary node (SN) in a wireless communication system, the method comprising:
receiving, from an integrated access and backhaul (IAB)-mobile terminal (MT) node, an IABotherinformation message for requesting Internet protocol (IP) address assignment; and
configuring an IP address of the IAB-MT node,
wherein receiving, from the IAB-MT node, the IABotherinformation message for requesting the IP address assignment comprises:
receiving the IABotherinformation message via a signaling radio bearer (SRB) 3 in case that the SRB3 is configured, and
receiving the IABotherinformation message via a master node (MN) in case that the SRB3 is not configured, and
wherein the SN is an IAB donor node.

22. The method of claim 21, wherein the IAB-MT node operates in new radio dual connectivity (NR-DC).

23. The method of claim 21, wherein the IABotherinformation message received via the MN is used for an IP address-related procedure.

24. The method of claim 23, wherein the IABotherinformation message received from the MN is received via a radio resource control (RRC) message transmitted to the MN by the IAB-MT node, and
wherein the RRC message comprises a ULInformationTransferMRDC message.

25. The method of claim 23, wherein the IP address-related procedure comprises requesting an IP address of the IAB-MT node or reporting the IP address of the IAB-MT node.

26. An integrated access and backhaul (IAB) node in a wireless communication system, the IAB node comprising:
a transceiver; and
at least one processor,
wherein the at least one processor is configured to:
in case that an IAB-mobile terminal (MT) node performs an Internet protocol (IP) address-related procedure for an IAB-donor central unit (CU) in a secondary node (SN), identify whether a signaling radio bearer (SRB) 3 is configured,
in case that the SRB3 is configured, transmit an IABotherinformation message to the SN via the SRB3,
in case that the SRB3 is not configured, transmit a radio resource control (RRC) message comprising the IABotherinformation message to a master node (MN), and
in case that the IAB-MT node performs the IP address-related procedure for an IAB-donor CU in the MN, provide the IABotherinformation message to a lower layer.

27. The IAB node of claim 26, wherein the IAB-MT node operates in new radio dual connectivity (NR-DC).

28. The IAB node of claim 26, wherein the IP address-related procedure comprises requesting an IP address of the IAB-MT node or reporting the IP address of the IAB-MT node.

29. The IAB node of claim 26, wherein the RRC message comprises a ULInformationTransferMRDC message.

30. The IAB node of claim 29, wherein the IABotherinformation message within the ULInformationTransferMRDC message is transferred to the SN.

31. A secondary node (SN) in a wireless communication system, the SN comprising:
a transceiver; and
at least one processor,
wherein the at least one processor is configured to:
receive, from an integrated access and backhaul (IAB)-mobile terminal (MT) node, an IABotherinformation message for requesting Internet protocol (IP) address assignment,
configure an IP address of the IAB-MT node,
in case that a signaling radio bearer (SRB) 3 is configured, receive the IABotherinformation message via the SRB3, and
in case that the SRB3 is not configured, receive the IABotherinformation message via a master node (MN), and
wherein the SN is an IAB donor node.

32. The SN of claim 31, wherein the IAB-MT node operates in new radio dual connectivity (NR-DC).

33. The SN of claim 31, wherein the IABotherinformation message received via the MN is used for an IP address-related procedure.

34. The SN of claim 33, wherein the IABotherinformation message received from the MN is received via a radio resource control (RRC) message transmitted to the MN by the IAB-MT node, and
wherein the RRC message comprises a ULInformationTransferMRDC message.

35. The SN of claim 33, wherein the IP address-related procedure comprises requesting an IP address of the IAB-MT node or reporting the IP address of the IAB-MT node.
